(19) United States
(12) Patent Application Publication
(10) Pub. No.: US 2018/0100551 A1
(43) Pub. Date: Apr. 12, 2018

(54) FORCE BALANCED BELLCRANK ACTUATOR FOR MULTI-MODE CLUTCH MODULE

(71) Applicant: BorgWarner Inc., Auburn Hills, MI (US)

(72) Inventors: Calahan CAMPTON, Royal Oak, MI (US); John F. GUZDEK, Clarkston, MI (US); Jennifer KADLEC, West Bloomfield, MI (US)

(21) Appl. No.: 15/566,522

(22) PCT Filed: Apr. 8, 2016
(86) PCT No.: PCT/US2016/026589

§ 371 Date: Oct. 13, 2017

Related U.S. Application Data
(60) Provisional application No. 62/147,694, filed on Apr. 15, 2015.

(51) Int. Cl. F16D 41/14; F16D 41/16

(52) U.S. Cl. CPC F16D 41/14; F16D 28/00; F16D 41/16

(57) ABSTRACT

An actuator for a multi-mode clutch module interacts with a bellcrank to selectively block interactions of pawls between inner and outer races of the module. The bellcrank pivots about a pin fixed to the outer race, converting linear motion of a plunger extending from the actuator into clockwise and counterclockwise motions of a cam ring between two angular limits by a torque arm fixed to the cam ring. The one-piece bellcrank includes three levers; one interacting with the plunger, a second containing a slot to engage the torque arm to control pawl movement, and a third having a mass greater than the first and second levers for providing inertial resistance to any uncommanded rotation of the bellcrank under externally induced G-forces. As such, the inner and outer races may be more reliably locked together in at least one clutch operating mode and can freewheel in the same clutch operating mode.

### CROSS-REFERENCE TO RELATED APPLICATION

This Application is a non-provisional patent application claiming priority under 35 USC § 119(e) to U.S. Provisional Patent Application Ser. No. 62/147,694 filed on Apr. 15, 2015.

### FIELD OF DISCLOSURE

The present disclosure relates generally to overrunning clutches for automotive transmissions, and more particularly to multiple mode clutch actuators employed in the operation of such transmissions.

### BACKGROUND OF DISCLOSURE

An automotive vehicle typically includes an internal combustion engine containing a rotary crankshaft configured to transfer motive power from the engine through a driveshaft to turn the wheels. A transmission is interposed between engine and driveshaft components to selectively control torque and speed ratios between the crankshaft and driveshaft. In a manually operated transmission, a corresponding manually operated clutch may be interposed between the engine and transmission to selectively engage and disengage the crankshaft from the driveshaft to facilitate manual shifting among available transmission gear ratios.

On the other hand, if the transmission is automatic, the transmission will normally include an internal plurality of automatically actuated clutch units adapted to dynamically shift among variously available gear ratios without requiring driver intervention. Pluralities of such clutch units, also called clutch modules, are incorporated within such transmissions to facilitate the automatic gear ratio changes.

In an automatic transmission for an automobile, anywhere from three to ten forward gear ratios may be available, not including a reverse gear. The various gears may be structurally comprised of inner gears, intermediate gears such as planet or pinion gears supported by carriers, and outer ring gears. Specific transmission clutches may be associated with specific sets of the selectable gears within the transmission to facilitate the desired ratio changes.

For example, one of the clutch modules of an automatic transmission associated with first (low) and reverse gear ratios may be normally situated at the front of the transmission and closely adjacent the engine crankshaft. The clutch may have an inner race and an outer race disposed circumferentially about the inner race. One of the races, for example the inner race, may in one mode be drivingly rotatable in only one direction. The inner race may he selectively locked to the outer race via an engagement mechanism such as, but not limited to, a roller, a sprag, or a pawl, as examples. In the one direction, the inner race may be effective to directly transfer rotational motion from the engine to the driveline.

Within the latter system, the outer race may he fixed to an internal case or driven housing of an associated planetary member of the automatic transmission. Under such circumstances, in a first configurational mode the inner race may need to be adapted to drive in one rotational direction, but freewheel in the opposite direction, in a condition referred to as overrunning. Those skilled in the art will appreciate that overrunning may be particularly desirable under certain operating states, as for example when a vehicle is traveling downhill. Under such circumstance, a driveline may occasionally have a tendency to rotate faster than its associated engine crankshaft. Providing for the inner race to overrun the outer race may avoid damage to the engine and/or transmission components.

In a second mode, such as when a vehicle may be in reverse gear, the engagement mechanisms may be adapted for actively engaging in both rotational directions of the inner race, thus not allowing for an overrunning condition in either direction, for example,

Because automatic transmissions include pluralities of gear sets accommodate multiple gear ratios, reliability of actuators used for automatically switching clutch modules between and/or among various available operating modes is a consistent design concern. One particular issue relates to the impact of G-forces on actuator assemblies and their associated components. In some instances, such structures can become unintentionally dislodged during travel over bumpy roads, for example. Therefore, efforts continue to be directed to finding ways to assure actuator reliability at competitive costs,

### SUMMARY OF DISCLOSURE

In accordance with le aspect of the disclosure, an actuator assembly for use with a multi-mode clutch module is disclosed. The clutch module has an inner race and an outer race, and a plurality of pawls circumferentially positioned between the inner and outer races. The actuator assembly includes an actuator cam ring having a torque arm and configured to move between at least two angular positions to selectively control movements of the pawls for locking and unlocking the races together.

In accordance with another aspect of the disclosure, the actuator assembly includes a reciprocal actuator including a housing, a translatable plunger having one end secured within the housing, the plunger having a free end.

In accordance with yet another aspect of the disclosure, a bellcrank is pivotally affixed to the outer race, the bellcrank having a first lever configured to receive the free end of the plunger, and a second lever containing a slot and configured to engage the torque arm for moving the actuator cam ring between the two angular positions.

In accordance with yet another aspect of the disclosure, the bellcrank includes a third lever having a mass relatively greater than either of the first and second levers. The mass of the third lever is configured to provide an inertial resistance to any uncommanded rotation of the bellcrank which can occur under externally induced G-forces.

In accordance with still another aspect of the disclosure, the actuator assembly moves the actuator cam ring to selectively block the pawls so that the inner race may lock to the outer race in a first rotational direction in one clutch operating mode, and freewheel relative to the outer race in the same clutch operating mode.

### BRIEF DESCRIPTION OF DRAWINGS

FIG. 1 is an elevational side view of a multiple mode clutch module that includes a force balanced bellcrank actuator assembly constructed in accordance with the present disclosure.

FIG. 2 is an enlarged view of a portion of the view of FIG. 1.

FIG. 2A is a cross-sectional view of the portion of structure depicted in FIG. 2, taken along lines 2A-2A of FIG. 2.

FIG. 3 is an enlarged view of the structure depicted in FIG. 2, albeit shown in a second mode configuration.

FIG. 3A is a cross-sectional view of the portion of structure depicted in FIG. 3, taken along lines 3A-3A of FIG. 3.

FIG. 4 is a perspective view of a bellcrank constructed in accordance with the present disclosure.

FIG. 5 is a view of the bellcrank of FIG. 4, shown interacting with several components.

FIG. 6 is a cross-sectional view of an alternate embodiment of a multiple mode clutch module that includes a force balanced bellcrank actuator assembly constructed in accordance with the present disclosure.

FIG. 7 is a cross-sectional view of the embodiment of FIG. 6, albeit shown in a different mode.

FIG. 8 is a cross-sectional view of the embodiment of FIGS. 6 and 7, shown in yet another mode.

FIG. 9 is a cross-sectional view of the embodiment of FIGS. 6 8, shown in vet another mode.

It should be understood that the drawings are not to scale, and that the disclosed embodiments are illustrated only diagrammatically and in partial views. It should also be understood that this disclosure is not limited to the particular embodiments illustrated herein.

### DETAILED DESCRIPTION

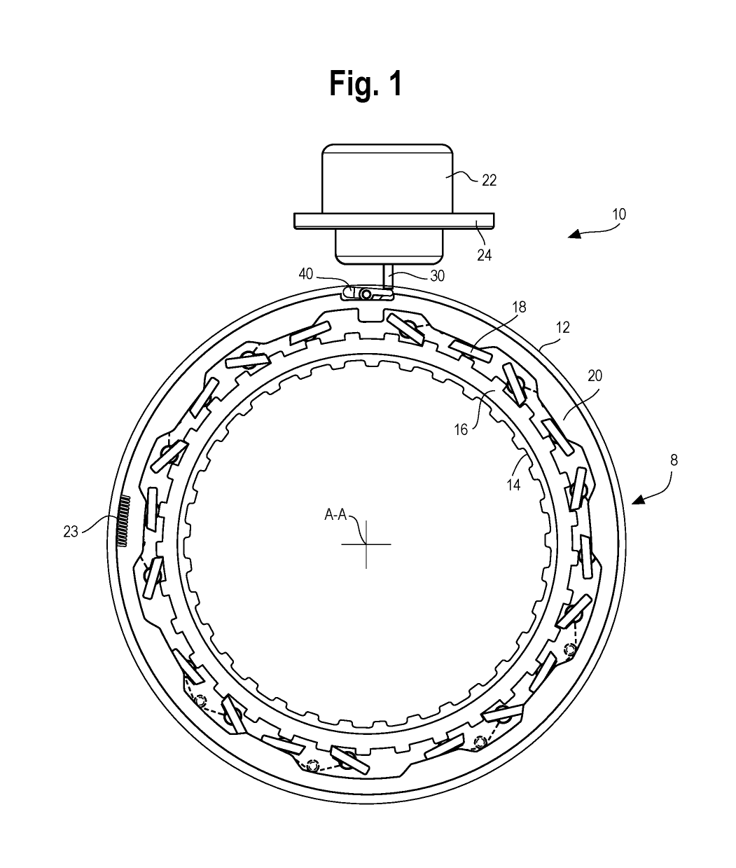

Referring to FIG. 1, a multiple mode clutch module 8 (also variously called a multi-mode clutch module or MMCM) having an axis “A-A” may be utilized in an automatic transmission (not shown). Such a transmission may be employed in a front-wheel driven automobile, for example, and the clutch module 8 may utilize a bellcrank actuator assembly 10, as herein described. The clutch module 8 may include an exterior case or housing 12, which may act as a driven outer race, as will be appreciated by those skilled in the art.

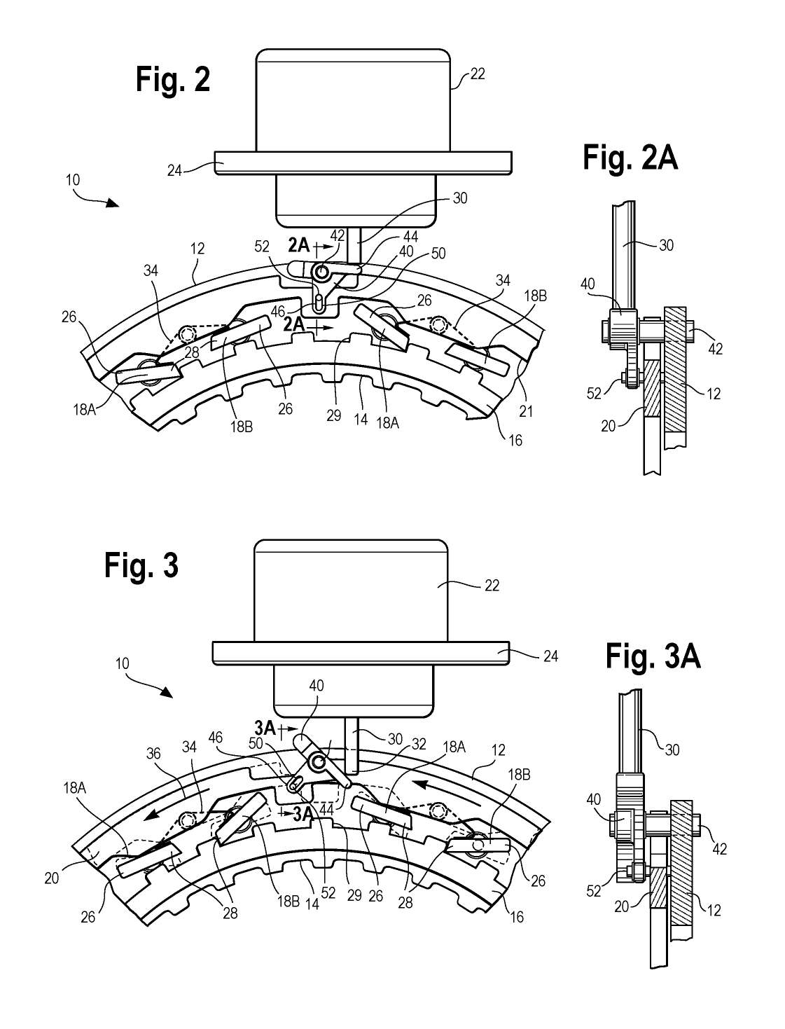

A splined interior hub 14 may be adapted for transfer of power from an engine (not shown) to a vehicular driveline (not shown). Referring now also to FIG. 2, the hub 14 may be integral to a driving; component, such as an inner race 16, and the inner and outer races 16, 12 may be selectively coupled together by a circumferential arrangement of pawls 18A and 18B.

Controlled movements of the pawls 18 may be achieved via an actuator cam ring 20 having radially arranged cam surfaces 21 configured to selectively block or unblock movement of otherwise spring-loaded pawls 18. For this purpose, the actuator cam ring 20 is rotatable between at least two angular limits, as further detailed below.

The actuator assembly 10 includes a reciprocal actuator 22, which may be powered by an electric solenoid or hydraulic source, supported within a housing 24 from which a plunger 30 extends. One end (not shown) of the plunger 30 is attached to a piston armature (not shown), and is supported for reciprocal movement within the housing 24 relative to a stator (not shown) that is fixedly supported within the housing 24. An opposite free end 32 of the plunger 30 is adapted to interact with a bellcrank 40, rotatably supported on a pivot pin 42 secured to and axially extending from the outer race 12. The bellcrank 40 has a slot 50, for interaction with a torque arm 52 fixed to and axially extending from the actuator cam ring 20. As such, the torque arm 52 is configured to cooperatively engage the slot 50 of the bellcrank to effect desired movement of the actuator cam ring 20, as described below. Those skilled in the art will appreciate that the slot 50 could alternatively be located in the actuator cam ring 20. For purposes of this disclosure, the alternative arrangements of the slot 50 may be deemed equivalent.

Referring now also to FIG. 3, as the plunger end 32 is urged downwardly by the reciprocal actuator 22, the plunger end 32 engages a lever 44 of the one-piece bellcrank 40. This causes the bellcrank 40 to rotate clockwise (from its position shown in FIG. 2), forcing the actuator cam ring 20 in an opposite or counterclockwise direction, shown by arrows 36, via interaction of-the torque arm 52 with the slot 50 situated within a second lever arm 46 of the bellcrank 40. Upon being rotated between such first and second angular limits (cf. FIGS. 2 and 3), the actuator cam ring 20 is adapted to selectively block interactions of the pawls 18 between the inner race 16 and the outer race 12, as will be described.

Those skilled in the art will appreciate that the counterclockwise angular movement of the actuator cam ring 20 occurs against a biasing spring force of at least one circumferential cam return spring 23 (FIG. 1). For this purpose, the return spring 23 is anchored on the outer race 12. Upon deactivation of the reciprocal actuator 22, the plunger 30 retracts to the position of FIG. 2, the actuator cam ring 20 in turn rotating clockwise via the cam return spring 23 back to its initial position of FIG. 2.

The limited angular rotation of the actuator cam ring 20 is effective to selectively control movement of the pawls 18 with respect to any given operating mode of the clutch module 8. For example, in this disclosure the plurality of pawls 18 are arranged in distinct interleaved sets of two, pawls 18A and 18B, each pawl having a heel end 26 and an opposite toe end 28, with the respective sets of pawls 18A and 189 being asymmetrically shaped, and reversely identical. The heel ends 26 are configured to interact with the cam surfaces 21 of the actuator cam ring 20. Axially oriented, circumferentially spaced cogs 29 are provided on the outside periphery of the interior driven hub 14 to be selectively engaged by toe ends 28 of the pawls. As such, the pawls 18A and 18B are adapted to normally interact with the cogs 29 under the force of pawl springs 34, unless blocked by cam surfaces 21 of the actuator cam ring 20, for supporting desired rotary movements of the inner race 16 about the axis A-A.

In the described configuration, the driven housing of the clutch module 8 includes the outer race 12. The actuator 22 (FIGS. 1, 2, and 3) is fixed to the outer race 12. The actuator cam ring 20, however, is moveably supported on the fixed outer race 12 for accommodating the described angular rotations, in both clockwise and counterclockwise directions, between the two limits about axis A-A.

As depicted and disclosed herein, the pawls 18 are elongated hardened steel members circumferentially positioned about the axis A-A of the clutch module 8. Alternatively, the pawls maybe forgings or other manufactured structures, otherwise generally adapted to handle required engagement loads between the inner and outer races 16. 12, as necessary.

In view of the foregoing, it will be appreciated that the actuator 22 ultimately controls movement of the actuator cam ring 20 which, in turn, rotates between the two angular positions. Actual positioning of the pawls 18A and 18B is in turn controlled by the cam surfaces 21 against forces of the pawl springs 34.

Referring now specifically to FIGS. 2 and 3, when the actuator cam ring 20 is in a first (FIG. 2) of its two angular positions, one set of the opposed pawls, e.g. pawls 18A, will drivingly lock the driving inner race 16 to the driven outer race 12 in only the one direction; i.e. counterclockwise, as for example to accommodate a reverse gear configuration. Conversely, freewheeling of the race 16 will occur when that race is rotated in a clockwise direction.

Alternatively, when the actuator cam ring 20 is in the second of its two angular positions (FIG. 3), the pawls 18B will lock the driving inner race to the driven outer race during clockwise rotation of the driving inner race 16. Conversely, also in the latter position of the actuator cam ring 20, the race 16 will be able to freewheel when rotating counterclockwise to permit overrunning. In both described configurations of the multi-mode clutch 8, the outer race 12 is driven, and thus otherwise grounded relative to an interior case or housing of an associated transmission (not shown).

As disclosed, each individual pawl 18A, 18B is urged radially inwardly against the cogs 29 of the inner race 16 via a single spring 34. Although only a leaf-style spring is depicted, alternative spring types or even other biasing arrangements may be employed. For example, coil springs could be used; e.g., one for each pair of opposed pawls 18A, 18B.

The structures herein described may have alternative configurations, although not shown or described herein. For example, the actuator 22 may be actuated hydraulically instead of electrically. In addition, the biasing system for returning the actuator cam ring 20 may utilize a spring structure other than a conventional-style coil spring (FIG. 1) as the return spring 23. Although these modifications constitute only two examples, numerous other variations are applicable within the context of this disclosure.

For purposes of this disclosure, the bellcrank actuator assembly 10 includes at least the following components:
a) the reciprocal actuator 22;
b) the plunger 30;
c) the bellcrank 40, including both its pivot pin 42 and slot 50;
d) the cam return spring 23; and
e) the actuator cam ring 20, including the torque arm 52 as configured to interact with the slot 50.

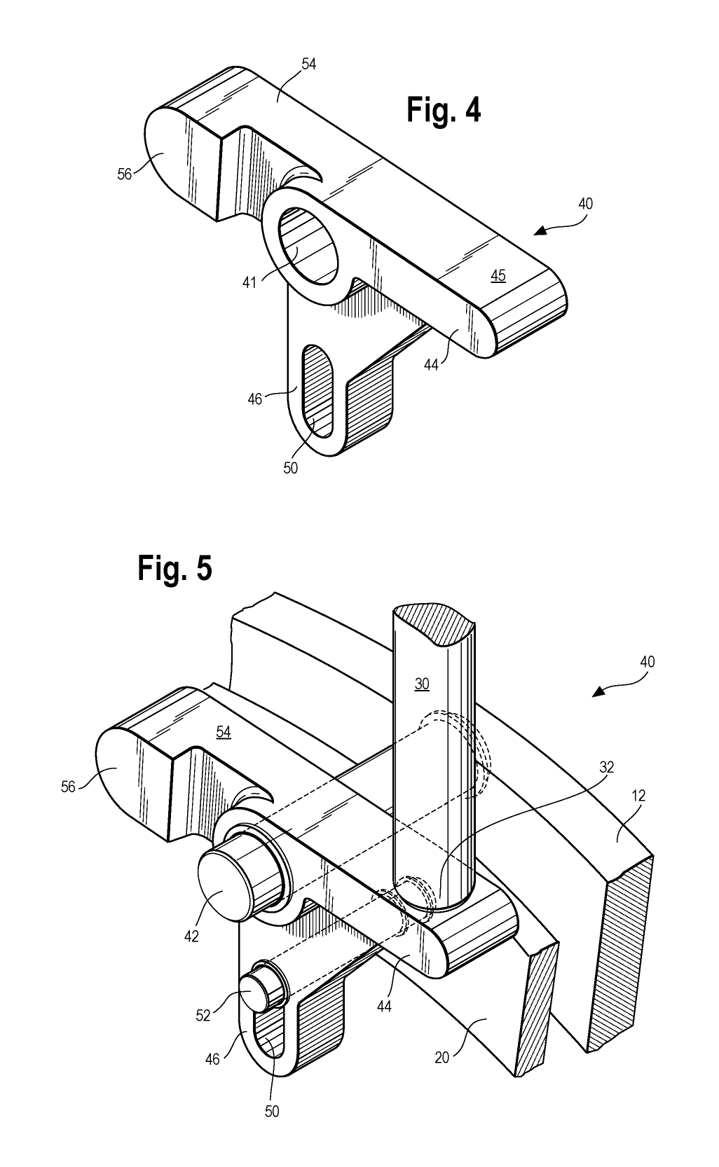

Referring now to FIGS. 4 and 5, the disclosed bellcrank 40 is depicted in greater detail. The bellcrank 40 is T-shaped in the disclosed embodiment, although non-orthogonal shapes may be utilized. The bell crank 40 includes an aperture 41 about which it pivots on the pivot pin 42 (FIG. 5; also in FIGS. 2A and 3A) about a fixed point of the housing 12. The bellcrank includes three separate levers; the first lever 44, described above, is configured to interact with the free end 32 of the plunger 30 (FIG. 5) over a contact surface 45 on the lever 44, as shown.

The second lever 46 is configured to interact with the previously described torque arm 52 (FIG, 5) which extends through the slot 50, as described in relation to the actuator cam ring 20. In the disclosed embodiment, the slot 50 extends symmetrically within, and has an identical orthogonal orientation as, the described second lever 46. A third lever 54, however, does not directly interact with any of the noted components, but rather incorporates an inertial mass 56 to counteract anticipated G-forces of the type induced on the bellcrank during rough travel, as for example as would be encountered on bumpy roads. The term G-forces as used herein refers to multiples of the force of gravity, also known as units of gravitational force, or G-units.

The physical size of the inertial mass 56 may be increased or reduced, as desired, by extending or shortening along either of its axial and/or radial dimensions, for any specific anticipated G-force encounters. In some situations, anticipated road force loads may be up to 20 times the force of gravity. Those skilled in the art will appreciate that such loads can tend to cause unintentional, uncommanded dislodgements of the bellcrank actuator assembly 10, i.e. rotation of the bellcrank 40 from an intended and/or previously commanded position. Use of a calculated predetermined inertial mass 56 will be effective to counter such an unintentional G-force reaction.

Finally, although the actuator assembly 10 has been described with respect to the provision of only two clutch modes, those skilled in the art will appreciate that the plunger 30 could be arranged to have an intermediate position which could facilitate an additional, or third mode such as a free-free mode, for example. In addition, although each of the three levers 44, 46, and 54 is depicted to have orthogonal relationships with respect to each other about the aperture 41, other angular orientations and/or shapes may be suitable, depending on space limitations and/or other factors.

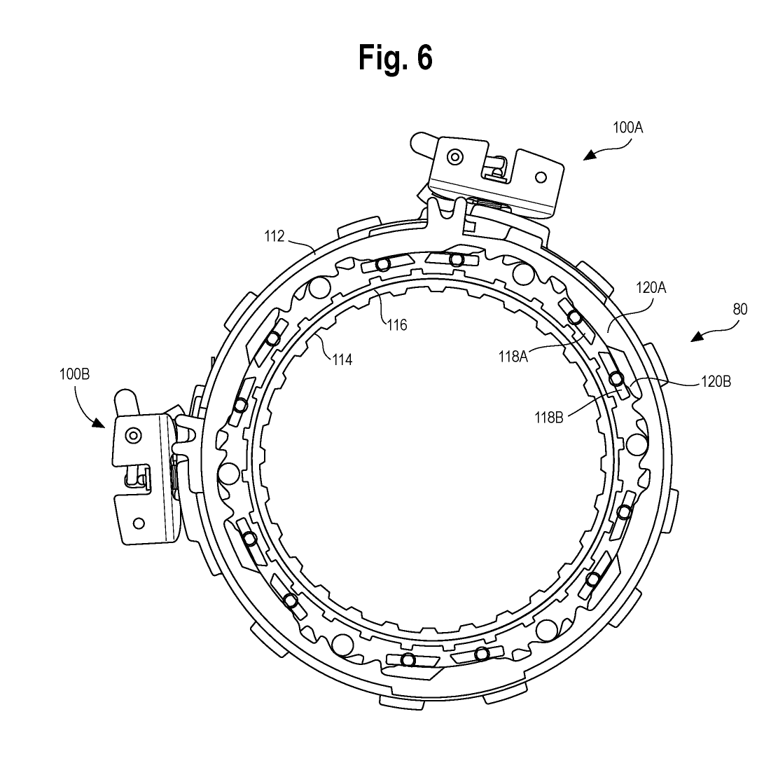

The above-described embodiment of the clutch module 8 utilizes a single actuator assembly 10 which produces two distinct modes, as has been particularly described in reference to FIGS. 2 and 3. An alternative embodiment of a clutch module 80 provides two additional modes, as disclosed in FIGS. 6-9, now described.

Referring initially to FIG. 6, the clutch module 80 includes dual bellcrank actuator assemblies depicted as 100A and 100B, respectively. As the clutch module 8 of FIGS. 1-3 incorporates an outer housing 12, the clutch module 80 of FIG. 6 may include an outer housing 112, which also acts as a driven outer race. Similarly, the clutch module 80 includes an interior driven hub 114 as part of an inner race 116 (cf. interior driven hub 14 and inner race 16 of clutch module 8).

The use of dual bellcrank actuator assemblies 100A and 100B can provide functionality beyond that offered by the clutch module 8, which employs only a single bellcrank actuator assembly 10. In the clutch module 80, the two sets of pawls 118A and 118B are controlled by two distinct actuator cam rings 120A and 120B to achieve a total of four modes, as opposed to just the two modes offered by the clutch module 8. For this purpose, those skilled in the art will appreciate that the cam ring 120A may be controlled by the actuator assembly 100A, while the cam ring 120B may be separately controlled by the actuator assembly 100B.

Various individual features of the clutch modules 8 and 80 operate analogously. For example, within the clutch module 8, movements of the pawls 18A, 18B caused by movements of respective heel ends 26 resulting from contact thereof by the free end 32 of the plunger 30, though not shown in FIGS. 6 9, have fully analogous counterparts within the clutch module 80. Moreover, each actuator assembly 100A, 100B includes an associated bellcrank, analogous to the bellcrank 40 associated with actuator assembly 10, earlier described. As such, those skilled in the art will appreciate that each of the two bellcrank mechanisms of the clutch module 80 are identical to and operate exactly as described earlier in reference to the single bellcrank actuator 40 of the clutch module 8.

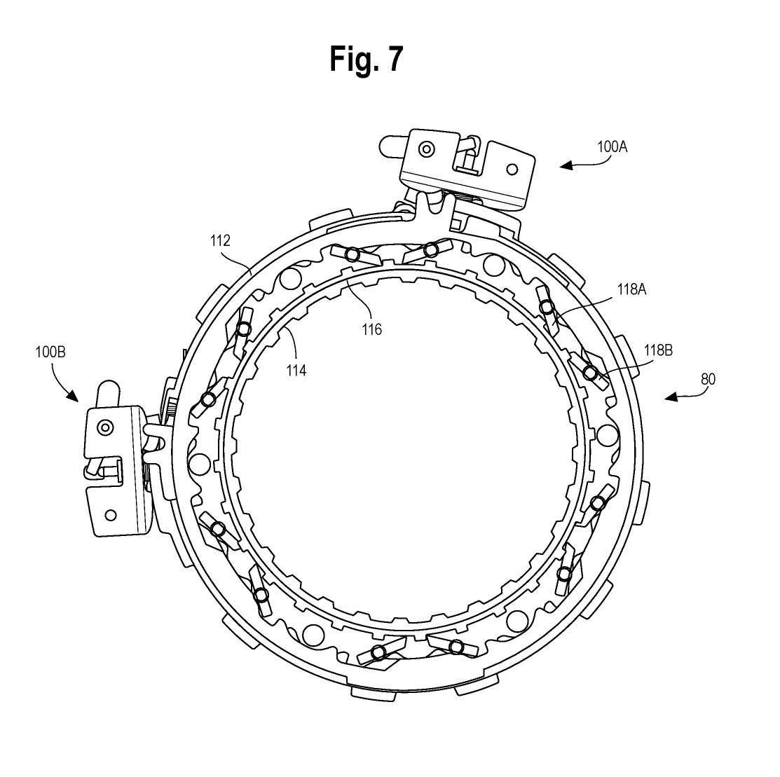

Referring now also to FIG. 7, it will be appreciated that the various clutch modes are established by positions of the pawls, as controlled by the dual actuator assemblies 100A, 100B. In FIG. 6, the first of the two additional modes is a so-called free-free mode, wherein the pawls 118A, 118B are positioned in a manner in which the inner race 116 is unrestricted with respect to movement relative to the outer race 112 in either the clockwise or counterclockwise rotational directions. In this mode of the clutch module 80, both actuator assemblies 100A, 100B are de-energized in this particular embodiment. Conversely, FIG. 7 depicts the second mode, a so-called lock-lock mode, in which the pawls 118A, 118B are positioned so as to restrict or lock movement of the inner race 116 relative to the outer race 112 in both clockwise and counterclockwise rotational directions. In this anode, both actuator assemblies 100A, 100B are energized.

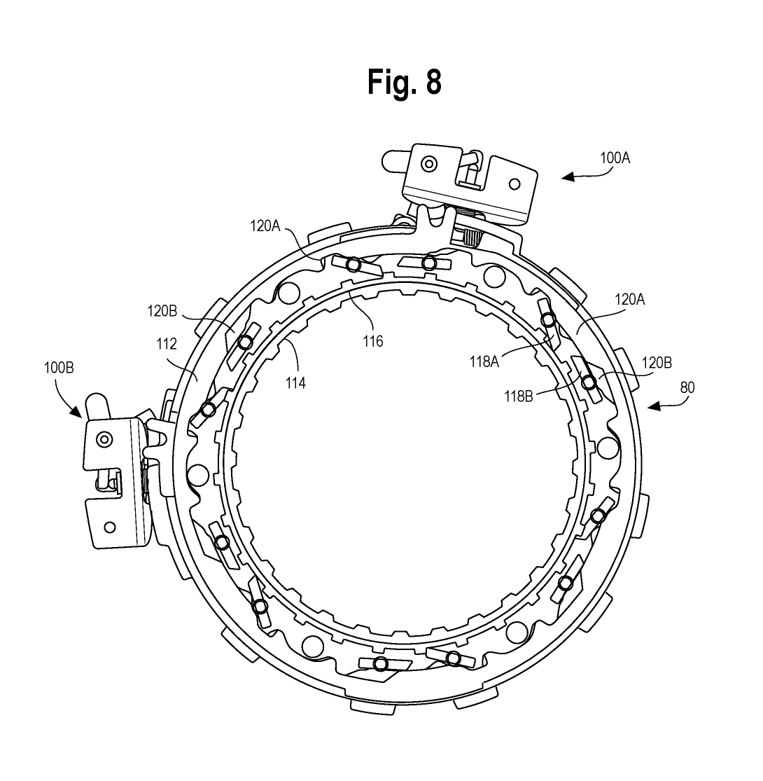

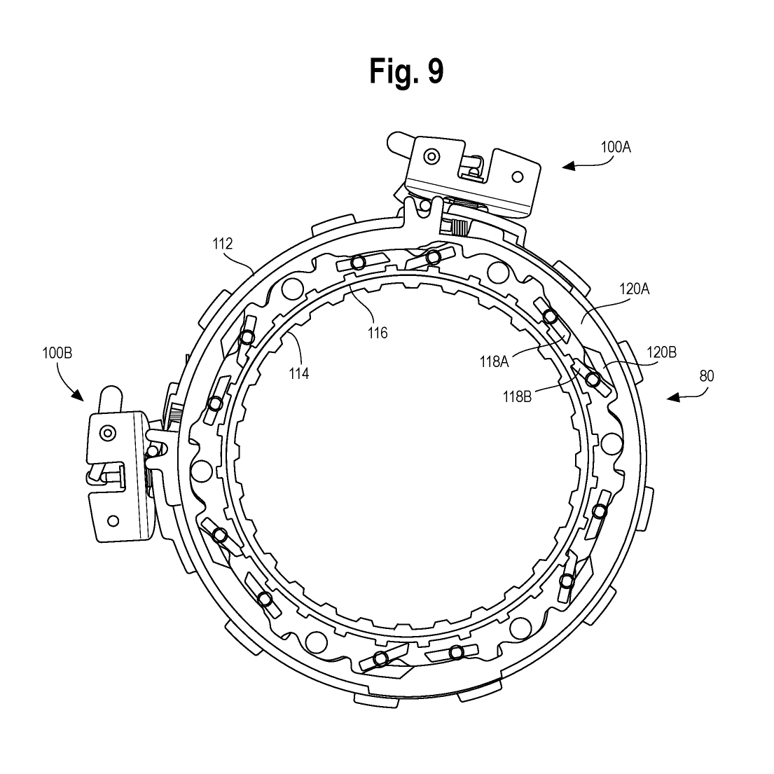

Finally referring now to FIGS. 8 and 9, the clutch module 80 is shown in counterclockwise and clockwise one-way clutch operative positions, analogous to the one-way clutch positions of the clutch module 8, as reflected in FIGS. 2 and 3.

respectively. For achieving these respective modes, the actuator assembly 100A is energized while the actuator assembly 100B is de-energized in the one-way mode of FIG. 8. Conversely, in the opposite one-way mode shown in FIG. 9, the actuator 100A is de-energized, while the actuator 100B is energized.

Those skilled in the art will appreciate that numerous other embodiments may be available under the disclosure and claims as presented herein. For example, although the outer race 12, 112 has been described herein as a driven race, while the inner race 16, 116 has been described as a driving race, the two races could be arranged with opposite functionalities in alternative embodiments of the clutch module 8, 80.

### Industrial Applicability

The clutch module, including the actuator, of this disclosure may be employed in a variety of vehicular applications, including but not limited to, automobiles, trucks, off-road vehicles, and other machines of the type having engines, automatic transmissions, and drivelines.

The disclosed clutch module actuator assembly offers a unique approach to managing movements of pawls adapted to engage the inner and outer races of clutch modules used in automatic transmissions. Use of a bellcrank in accordance with this disclosure may offer additional design opportunities for clutch modules utilized in automatic transmissions.

1. An actuator assembly configured for use with a multi-mode clutch module having an inner race and an outer race, and a plurality of pawls circumferentially positioned between the inner and outer races; the actuator assembly comprising:
an actuator cam ring having a torque arm; the actuator cam ring being configured to move between at least two angular positions, and adapted to selectively control movements of the pawls for locking and unlocking the races together;
a reciprocal actuator including a housing;
an elongated plunger having one end translatably secured within the housing, the plunger having a free end; and
a bellcrank pivotally affixed to the outer race, the bellcrank having a first lever configured to receive the free end of the plunger, a second lever containing a slot configured to engage the torque arm for moving the actuator cam ring between the two angular positions, and a third lever having a mass relatively greater than either of the first and second levers, the mass of the third lever being configured to provide inertial resistance against uncommanded rotation of the bellcrank due to externally induced G-forces; and
wherein the actuator assembly moves the actuator cam ring to selectively block the pawls so that the inner race locks to the outer race in a first rotational direction in one clutch operating mode, and freewheels relative to the outer race in an opposite rotational direction in the same clutch operating mode.

2. The actuator assembly of claim 1, wherein the inner race locks to the outer race in the opposite rotational direction, and freewheels with respect to the outer race in the first rotational direction.

3. The actuator assembly of claim 1, wherein the outer race comprises a driven housing to which the bellcrank is pivotally affixed.

4. The actuator assembly of claim 1, wherein the first, second, and third levers of the bellcrank are disposed orthogonally with respect to one another.

5. The actuator assembly of claim 1, wherein the bellcrank is T-shaped.

6. The actuator assembly of claim 4, wherein the slot of the second lever extends symmetrically within and shares the orthogonal orientation of the second lever.

7. The actuator assembly of claim 1, wherein the inner race is a driving race.

8. A multi-mode clutch module having at least two actuator assemblies configured for use with an automatic transmission, the multi-mode clutch module having an inner race and an outer race, and a plurality of pawls circumferentially positioned between the inner and outer races; each actuator assembly comprising:
an actuator cam ring having a torque arm; the actuator cam ring being configured to move between at least two angular positions, and adapted to selectively control movements of pawls associated with one of the actuator assemblies for locking and unlocking the races together;
each actuator assembly further comprising a reciprocal actuator including a housing;
an elongated plunger having one end translatably secured within the housing, the plunger having a free end; and
a bellcrank pivotally affixed to the outer race, the bellcrank having a first lever configured to receive the free end of the plunger, a second lever containing a slot configured to engage the torque arm for moving the actuator cam ring between the two angular positions, and a third lever having a mass relatively greater than either of the first and second levers, the mass of the third lever being configured to provide inertial resistance against uncommanded rotation of the bellcrank due to externally induced G-forces; and
wherein each actuator assembly independently moves an associated actuator cam ring to selectively block pawls associated therewith to provide four distinct modes, including one mode wherein the inner race locks to the outer race in a first rotational direction in that clutch operating mode, and freewheels relative to the outer race in an opposite rotational direction in the same clutch operating mode.

9. The clutch module of claim 8, wherein the inner race locks to the outer race in the opposite rotational direction, and freewheels with respect to the outer race in the first rotational direction.

10. The clutch module of claim 8, wherein the outer race comprises a driven housing to which the bellcrank is pivotally affixed.

11. The clutch module of claim 8, wherein the first, second, and third levers of the bellcrank are disposed orthogonally with respect to one another.

12. The clutch module of claim 8, wherein the bellcrank is T-shaped.

13. The clutch module of claim 12, wherein the slot of the second lever extends symmetrically within and shares the orthogonal orientation of the second lever.

14. The clutch module of claim 8, wherein the inner race is a driving race.

15. A method of making a bellcrank actuator assembly configured for use with a multi-mode clutch module having an inner race and an outer race, and a plurality of pawls circumferentially positioned between the inner and outer races; the method including the steps of:
forming an actuator cam ring having a torque arm; configuring the actuator cam ring to move between at least two angular positions to selectively control movements of the pawls for locking and unlocking the races together;
fixing a reciprocal actuator to the outer race, the reciprocal actuator having a housing;
inserting an elongated plunger having one end translatably secured to the housing, the plunger having a free end;
pivotally affixing a bellcrank to the outer race, the bellcrank being formed with a first lever configured to receive the free end of the plunger, a second lever containing a slot configured to engage the torque arm for moving the actuator cam ring between the two angular positions, and a third lever having a mass relatively greater than either of the first and second levers, the mass of the third lever being configured to provide inertial resistance against uncommanded rotation of the bellcrank due to externally induced G-forces; and
causing the actuator assembly to move the actuator cam ring to selectively block the pawls so that the inner race locks to the outer race in a first rotational direction in one clutch operating mode, and freewheels relative to the outer race in an opposite rotational direction in the same clutch operating mode.
